(19) United States
(12) Patent Application Publication
(10) Pub. No.: US 2025/0280472 A1
(43) Pub. Date: Sep. 4, 2025

(54) AEROSOL GENERATING DEVICE AND HEATING STRUCTURE THEREOF, HEATING ELEMENT AND METHOD FOR MANUFACTURING HEATING ELEMENT

(71) Applicant: SMOORE INTERNATIONAL HOLDINGS LIMITED, George Town (KY)

(72) Inventors: Lei MA, Shenzhen (CN); Hongming ZHOU, Shenzhen (CN); Rihong LI, Shenzhen (CN); Xianwu DU, Shenzhen (CN); Guo ZHANG, Shenzhen (CN); Yu WANG, Shenzhen (CN)

(21) Appl. No.: 19/210,907

(22) Filed: May 16, 2025

Related U.S. Application Data
(63) Continuation of application No. PCT/CN2023/114116, filed on Aug. 21, 2023.

(30) Foreign Application Priority Data
Nov. 17, 2022 (CN) 202211442117.6

(51) Int. Cl. H05B 6/00; A24F 40/46

(52) U.S. Cl. CPC H05B 6/00; A24F 40/46

(57) ABSTRACT

A heating structure includes: a heating element; and a tube body. The heating element includes a heating substrate and an infrared radiation layer provided on an outer surface of the heating substrate. The heating substrate is powered on for heating and exciting the infrared radiation layer to radiate infrared light waves. The heating element is at least partially spaced apart from a tube wall of the tube body. The tube wall of the tube body allows the infrared light waves to penetrate through. The infrared light waves heat an aerosol generating substrate.

### CROSS-REFERENCE TO PRIOR APPLICATION

This application is a continuation of International Patent Application No. PCT/CN2023/114116, filed on Aug. 21, 2023, which claims priority to Chinese Patent Application No. 202211442117.6, filed on Nov. 17, 2022. The entire disclosure of both applications is hereby incorporated by reference herein.

### FIELD

The present disclosure relates to the field of heat-not-burning (HNB) atomization, in particular to an aerosol generating device and a heating structure thereof, a heating element and a method for manufacturing the heating element.

### BACKGROUND

In the field of heat-not-burning (HNB) atomization, heating methods such as heating by a central heating element or by a peripheral heating element are employed generally. The common practice is that the heating element generates heat, and the heat is then directly transferred to an aerosol generating substrate through heat conduction. The substrate will generally be atomized within a temperature range of 350° C. or less. This heating method has a disadvantage in that the heating element directly or indirectly conducts the heat to the aerosol generating substrate by means of a solid material. This requires that the operating temperature of the heating element not be too high; otherwise, it will cause the substrate to overheat or the solid material to produce an unpleasant smell, thereby affecting the vaping experience. In addition, the existing E-cigarettes typically require relatively long preheating time before being vaped, with current market products averaging over 15 seconds, thereby greatly affecting the experience of a consumer.

### SUMMARY

In an embodiment, the present invention provides a heating structure, comprising: a heating element; and a tube body, wherein the heating element comprises a heating substrate and an infrared radiation layer provided on an outer surface of the heating substrate, wherein the heating substrate is configured to be powered on for heating and exciting the infrared radiation layer to radiate infrared light waves, wherein the heating element is at least partially spaced apart from a tube wall of the tube body, wherein the tube wall of the tube body is configured to allow the infrared light waves to penetrate through, and wherein the infrared light waves are configured to heat an aerosol generating substrate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol generating device in a first embodiment of the present disclosure;

FIG. 2 is a schematic structural diagram of a heating structure in the aerosol generating device shown in FIG. 1;

FIG. 3 is a sectional view of the heating structure shown in FIG. 2;

FIG. 4 is a schematic exploded view of the heating structure shown in FIG. 2;

FIG. 5 is a schematic structural diagram of a heating element of the heating structure shown in FIG. 4;

FIG. 6 is a cross-sectional view of the heating element shown in FIG. 5;

FIG. 7 is a temperature change graph during operation of the heating element shown in FIG. 1;

FIG. 8 is a cross-sectional view of a heating element of an aerosol generating device in a second embodiment of the present disclosure;

FIG. 9 is a cross-sectional view of a heating element of an aerosol generating device in a third embodiment of the present disclosure;

FIG. 10 is a schematic structural diagram of a heating structure of an aerosol generating device in a fourth embodiment of the present disclosure;

FIG. 11 is a schematic structural diagram of the heating structure shown in FIG. 10 from another perspective;

FIG. 12 is a sectional view of the heating structure shown in FIG. 10;

FIG. 13 is a schematic exploded view of the heating structure shown in FIG. 10;

FIG. 14 is a schematic structural diagram of a heating element of an aerosol generating device in a fifth embodiment of the present disclosure;

FIG. 15 is a cross-sectional view of the heating element shown in FIG. 14;

FIG. 16 is a cross-sectional view of a heating element of an aerosol generating device in a sixth embodiment of the present disclosure;

FIG. 17 is a schematic structural diagram of a heating element of an aerosol generating device in a seventh embodiment of the present disclosure;

FIG. 18 is a schematic structural diagram of a heating element of an aerosol generating device in an eighth embodiment of the present disclosure;

FIG. 19 is a schematic structural diagram of a heating element of an aerosol generating device in a tenth embodiment of the present disclosure;

FIG. 20 is a schematic structural diagram of a heating element of an aerosol generating device in an eleventh embodiment of the present disclosure;

FIG. 21 is a schematic structural diagram of a heating element of an aerosol generating device in a twelfth embodiment of the present disclosure;

FIG. 22 is a schematic exploded view of the heating element shown in FIG. 21;

FIG. 23 is a schematic structural diagram of a heating element of an aerosol generating device in a thirteenth embodiment of the present disclosure;

FIG. 24 is a sectional view of a heating structure of an aerosol generating device in a fourteenth embodiment of the present disclosure;

FIG. 25 is a schematic exploded view of the heating structure of the aerosol generating device shown in FIG. 24;

FIG. 26 is a sectional view of a heating structure of an aerosol generating device in a fifteenth embodiment of the present disclosure; and

FIG. 27 is a schematic exploded view of the heating structure of the aerosol generating device shown in FIG. 26.

### DETAILED DESCRIPTION

In an embodiment, the present invention provides an improved heating structure and aerosol generating device, a further improved heating element and a method for manufacturing the heating element.

In an embodiment, the present invention provides a heating structure. The heating structure includes a heating element and a tube body. The heating element includes a heating substrate and an infrared radiation layer provided on the outer surface of the heating substrate; the heating substrate is powered on for heating and exciting the infrared radiation layer to radiate infrared light waves; the heating element is at least partially spaced apart from the tube wall of the tube body; the tube wall of the tube body allows the infrared light waves to penetrate through; and the infrared light waves are configured to heat an aerosol generating substrate.

In some embodiments, the tube body is infrared-transparent glass, transparent ceramic or diamond.

In some embodiments, the maximum operating temperature of the heating element is 500° C.-1300° C.

In some embodiments, operating temperature intervals of the heating element include at least a first operating temperature interval and a second operating temperature interval, the maximum temperature of the first operating temperature interval is 700° C.-1300° C., and the maximum temperature of the second operating temperature interval is 500° C.-800° C.

In some embodiments, the heating element is completely spaced apart from the tube wall of the tube body.

In some embodiments, the heating element is provided in no direct contact with the tube body.

In some embodiments, the tube wall of the tube body has a thickness of 0.15 mm-0.6 mm.

In some embodiments, the spacing between the tube wall of the tube body and the heating element is 0.05 mm-1 mm.

In some embodiments, the heating substrate has a circular strip shape in cross section, and the radial dimension of the heating substrate is 0.15 mm-0.8 mm.

In some embodiments, the heating substrate has a flat strip shape in cross section, and the heating substrate has a thickness of 0.15 mm-0.8 mm.

In some embodiments, the heating substrate is in the shape of a sheet, a mesh or a film, and the heating substrate has a thickness of 10 um-500 um.

In some embodiments, the infrared radiation layer has a thickness of 10 um-300 um.

In some embodiments, the heating structure further includes an anti-oxidation layer provided between the heating substrate and the infrared radiation layer.

In some embodiments, the anti-oxidation layer has a thickness of 1 um-150 um.

In some embodiments, the heating structure further includes a binding layer provided between the anti-oxidation layer and the infrared radiation layer.

In some embodiments, the binding layer has a thickness of 10 um-70 um.

In some embodiments, the infrared radiation layer includes an infrared layer and/or a composite infrared layer, and the composite infrared layer is formed by compounding an infrared layer-forming substrate and a binding body configured to bind to the anti-oxidation layer.

In some embodiments, the heating substrate includes a metal substrate; and the metal substrate includes a nickel-chromium alloy substrate or an iron-chromium-aluminum alloy substrate.

In some embodiments, the tube body is in the shape of a hollow tube in which a first accommodating cavity configured to accommodate the heating element is formed.

In some embodiments, the heating element is arranged longitudinally.

In some embodiments, the heating element is in the shape of a column, a strip, a sheet, a spiral or a mesh.

In some embodiments, the heating element is at least partially bent.

In some embodiments, the heating element is bent to form a heating portion having at least one bending segment; and the heating portion is in the shape of a column, a spiral or a mesh.

In some embodiments, the heating elements are spaced apart from the periphery of the tube body, and the tube body is hollow inside to form a second accommodating cavity configured to accommodate an aerosol generating substrate.

In some embodiments, the tube body includes a first tube body allowing light waves to penetrate through and a second tube body provided on the periphery of the first tube body;
a spacing is reserved between the second tube body and the first tube body, and the spacing forms the first accommodating cavity for accommodating the heating element; and
the heating element is provided on the periphery of the first tube body and spaced apart from the first tube body.

The present disclosure further constructs an aerosol generating device. The aerosol generating device includes the heating structure according to the present disclosure and a power supply assembly configured to supply power to the heating structure.

The present disclosure further constructs a heating element. The heating element includes a heating substrate and an infrared radiation layer provided on the outer surface of the heating substrate. The heating substrate is powered on for heating and exciting an infrared radiation layer to radiate infrared light waves to heat an aerosol generating substrate installed in an accommodating cavity of an aerosol generating device, and the heating substrate is spaced apart from the cavity wall of the accommodating cavity.

In some embodiments, the heating substrate has a circular strip shape in cross section, and the radial dimension of the heating substrate is 0.15 mm-0.8 mm.

In some embodiments, the heating substrate is in the shape of a sheet, and the heating substrate has a thickness of 0.15 mm-0.8 mm.

In some embodiments, the infrared radiation layer has a thickness of 10 um-300 um.

In some embodiments, the heating structure further includes an anti-oxidation layer provided between the heating substrate and the infrared radiation layer.

In some embodiments, the anti-oxidation layer has a thickness of 1 um-150 um.

In some embodiments, the heating structure further includes a binding layer provided between the anti-oxidation layer and the infrared radiation layer.

In some embodiments, the binding layer has a thickness of 10 um-70 um.

In some embodiments, the infrared radiation layer includes an infrared layer and/or a composite infrared layer, and the composite infrared layer is formed by compounding an infrared layer-forming substrate and a binding body configured to bind to the anti-oxidation layer.

In some embodiments, the heating substrate includes a metal substrate; and the metal substrate includes a nickel-chromium alloy substrate or an iron-chromium-aluminum alloy substrate.

In some embodiments, the maximum operating temperature of the heating element is 500° C.-1300° C.

In some embodiments, operating temperature intervals of the heating element include at least a first operating temperature interval and a second operating temperature interval, the maximum temperature of the first operating temperature interval is 700° C.-1300° C., and the maximum temperature of the second operating temperature interval is 500° C.-800° C.

In some embodiments, the heating element is arranged longitudinally.

In some embodiments, the heating element is in the shape of a strip, a sheet, a spiral or a mesh.

The present disclosure further constructs a method for manufacturing a heating element. The method includes the following steps:
selecting a heating substrate-forming substrate to form a heating substrate; and
performing heat treatment on an infrared radiation layer-forming substrate on the outer surface of the heating substrate, allowing an infrared radiation layer to be formed on the outer surface of the heating substrate.

In some embodiments, the method further includes: providing an anti-oxidation layer on the outer surface of the heating substrate, and forming the infrared radiation layer on one side of the anti-oxidation layer away from the heating substrate.

In some embodiments, the method further includes: coating a binding body on the anti-oxidation layer to form a binding layer, the binding body being configured to bind the anti-oxidation layer to the infrared radiation layer.

In some embodiments, the infrared radiation layer includes an infrared layer and/or a composite infrared layer, and the composite infrared layer is formed by compounding an infrared layer-forming substrate and a binding body configured to bind to the anti-oxidation layer.

In some embodiments, the heating substrate includes a metal substrate; and the metal substrate includes a nickel-chromium alloy substrate or an iron-chromium-aluminum alloy substrate.

In some embodiments, the heating substrate has a circular strip shape in cross section, and the radial dimension of the heating substrate is 0.15 mm-0.8 mm.

In some embodiments, the heating substrate is in the shape of a sheet, and the heating substrate has a thickness of 0.15 mm-0.8 mm.

In some embodiments, the infrared radiation layer has a thickness of 10 um-300 um.

In some embodiments, the anti-oxidation layer has a thickness of 1 um-150 um.

In some embodiments, the binding layer has a thickness of 10 um-70 um.

The aerosol generating device and the heating structure thereof, the heating element and the method for manufacturing the heating element have the following beneficial effects. According to the heating structure, the infrared radiation layer is provided on the outer surface of the heating substrate; when the heating substrate generates heat in a powered-on state, the heat may excite the infrared radiation layer to radiate infrared light waves; the infrared light waves may penetrate through the tube body to heat the aerosol generating substrate. Because the heating element is spaced apart from the tube body, the maximum operating temperature of the heating element can exceed 500° C. or even reach more than 1000° C. within a short time (the operating temperature of the conventional HNB heating element generally does not exceed 400° C.). This not only prevents the aerosol generating substrate from overheating but also significantly enhances the vaping experience. Moreover, the preheating time is greatly reduced, allowing users to start vaping almost immediately upon inserting the aerosol generating substrate, which greatly improves the experience of a consumer.

To provide a clearer understanding of the technical features, objectives, and effects of the present disclosure, specific implementations of the present disclosure are described with reference to the accompanying drawings.

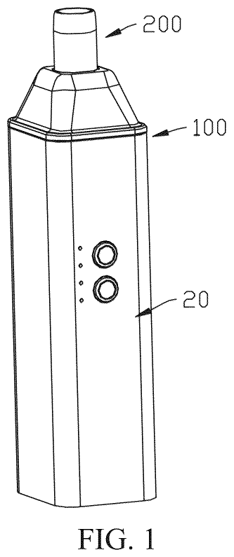

FIG. 1 shows a first embodiment of an aerosol generating device of the present disclosure. The aerosol generating device 100 may heat an aerosol generating substrate 200 in a low-temperature HNB manner, and has good atomization stability and good atomization taste. In some embodiments, the aerosol generating substrate 200 may be provided on the aerosol generating device 100 in a pluggable manner. The aerosol generating substrate 200 may be columnar. Specifically, the aerosol generating substrate 200 may be a solid material in the shape of a filament or sheet that is made of leaves and/or stalks of a plant, and an aroma component may be further added to the solid material.

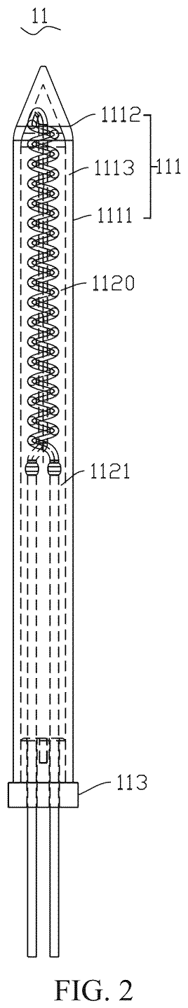

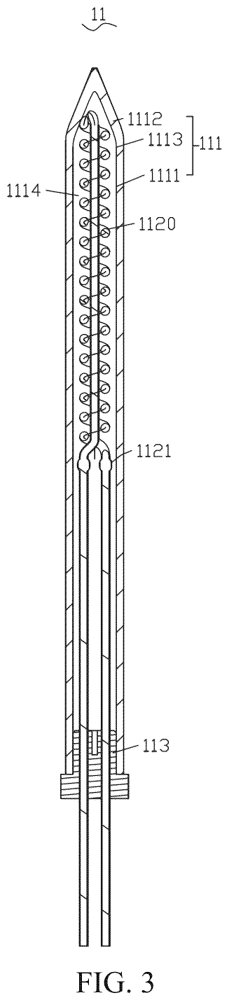

As shown in FIG. 2 and FIG. 3, further, in this embodiment, the aerosol generating device 100 includes a heating structure 11 and a power supply assembly 20. The heating structure 11 may be partially inserted into the aerosol generating substrate 200. Specifically, the heating structure may be partially inserted into a substrate section of the aerosol generating substrate 200, and infrared light waves are generated in a powered-on state to heat the substrate section of the aerosol generating substrate 200, so that the aerosol generating substrate 200 is atomized to generate aerosol. The heating structure 11 has the advantages of simple structure, high atomization efficiency, strong stability, and long service life. The power supply assembly 20 is configured to supply power to the heating structure 11. Specifically, in some embodiments, the heating structure 11 is detachably mounted in a shell of the power supply assembly 20, and may be mechanically and/or electrically connected to a power supply in the power supply assembly 20. The heating structure 11 may be detachably mounted in the shell of the power supply assembly 20, thereby facilitating replacement of the heating structure 11.

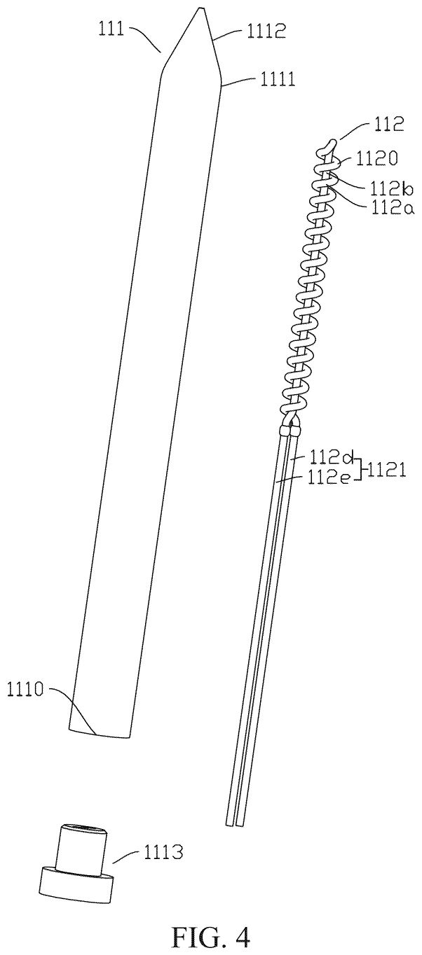

As shown in FIG. 3 and FIG. 4, in this embodiment, the heating structure 11 includes a tube body 111, a heating element 112 and a base 113. The tube body 111 is provided to cover at least part of the heating element 112, and may allow light waves to penetrate into the aerosol generating substrate 200. Specifically, in this embodiment, the tube body 111 may allow the infrared light waves to penetrate through, so that the heating element 112 may radiate infrared light waves to heat the aerosol generating substrate 200. The base 113 is provided at an opening 1110 of the tube body 111, and configured to fix the tube body 111 or seal the opening 1110 of the tube body 111.

In this embodiment, the tube body 111 may be a quartz glass tube. Of course, it may be understood that, in some other embodiments, the tube body 111 is not limited to a quartz tube, or may be other window material that may allow light waves to penetrate through, for example, infrared-transparent glass, transparent ceramics, or diamond.

In this embodiment, the tube body 111 is in the shape of a hollow tube and has two ends distributed along an axial direction. Specifically, the tube body 111 includes a tubular body 1111 having a circular cross section and a pointed top structure 1112 provided at one end of the tubular body 1111. Of course, it may be understood that, in some other embodiments, the cross section of the tubular body 111 is not limited to a circular shape. The tubular body 1111 is a hollow structure provided with an opening 1110 at one end. The pointed top structure 1112 is provided at one end of the tubular body 1111 away from the opening 1110. By providing the pointed top structure 1112, at least part of the heating structure 111 is provided in the aerosol generating substrate 200 in a pluggable manner. In this embodiment, a first accommodating cavity 1113 is formed on the inner side of the tube body 111, and the first accommodating cavity 1113 is a columnar cavity. In some other embodiments, the heating elements 112 may be spaced apart from the periphery of the tube body 111, and a second accommodating cavity for accommodating the aerosol generating substrate 200 may be formed on the inner side of the tube body 111.

In this embodiment, the tube wall of the tube body 111 is spaced apart from the entire heating element 112. For example, a gap 1114 is reserved between the tube body 111 and the heating element 112. The gap 1114 may be filled with air. Of course, it may be understood that, in some other embodiments, the gap 1114 may also be filled with a reducing gas or an inert gas. By reserving the gap 1114, there is no direct contact between the tube body 111 and the heating element 112. In some embodiments, the heating element 112 may also be partially spaced apart from the tube wall of the tube body 111. Specifically, the radial dimension of a partial segment of the heating portion 1120 may be greater than the radial dimension of another partial segment, and the radial dimension of a partial segment of the heating portion 1120 may be equal to the inner diameter of the tube body 111, thereby achieving a position limiting function. Of course, it may be understood that, in some embodiments, the inner side of the tube wall 111 may partially project toward the heating element 112 to contact the heating element 112, thereby achieving a position limiting function. Of course, it may be understood that, in some other embodiments, an isolating and positioning structure may be provided on the heating element 112 or the tube wall of the tube body 111, so that the heating element 112 is not in direct contact with the tube wall of the tube body 111. For example, a ceramic ring, etc. is sleeved on a partial segment of the heating element 112. It needs to be noted that the foregoing gap may refer to a gap accessible to air, and does not mean that air or another gas necessarily exists. A vacuum state is also a form of the gap. To obtain a better vaping experience and prolong the service life of the heating element, the tube body 111 may also be provided by using vacuum or by sealing an open end.

The temperature at which the entire heating structure 11 heats the aerosol generating substrate 200 may be further configured by configuring the thickness of the tube wall and the spacing between the heating element 112 and the tube wall. Under the same temperature, as the thickness of the tube wall increases, the overall irradiance may tend to decrease. Optionally, in some embodiments, the tube wall of the tube body 111 has a thickness of 0.15 mm-0.6 mm. In some embodiments, as the spacing between the heating element 112 and the tube wall increases, the temperature of the heating structure 11 may tend to gradually decrease. Preferably, in some embodiments, the spacing between the tube wall of the tube body 111 and the heating element 12 may be 0.05 mm-1 mm.

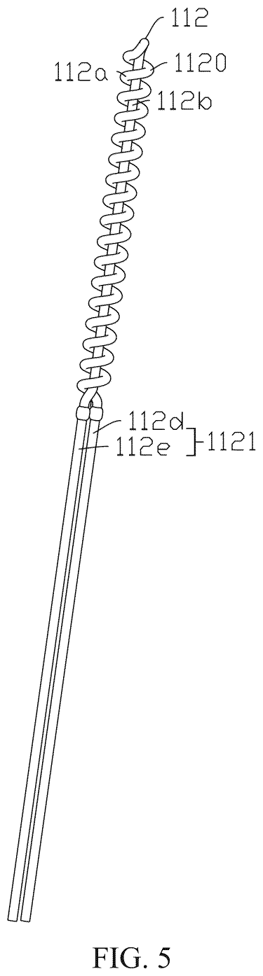

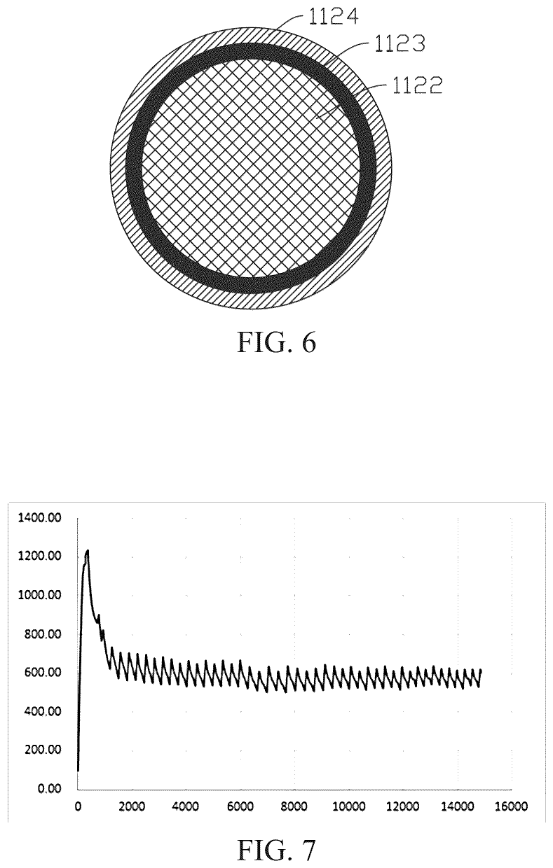

As shown in FIG. 5 and FIG. 6, in this embodiment, the heating element 112 may be one in number, may be provided lengthwise, and has a first free end 112d and a second free end 112e. In this embodiment, the heating element 112 is in the shape of a strip with a circular cross section. The heating element 112 is at least partially bent to form the columnar heating portion 1120 as a whole. Specifically, the heating element 112 may be bent to form a spirally columnar heating portion 1120. It may be understood that, in some other embodiments, the heating element 112 is not limited to a strip shape, and may be in the shape of a longitudinal sheet or mesh. The heating portion 1120 may be in the shape of a column, a sheet, a mesh or a strip. In some embodiments, the heating element 112 may be wound to form the heating portion 1120 having a single-spiral shape, a double-spiral shape, an M shape, an N shape, or other shapes. Of course, it may be understood that, in some other embodiments, the heating element 112 is not limited to one heating element, which may be two or more. It needs to be noted that, in some other embodiments, the heating element may also be a metal sheet or a metal pin.

In this embodiment, the heating portion 1120 includes a first heating portion 112a and a second heating portion 112b; and one end of the first heating portion 112a is connected to one end of the second heating portion 112b. In this embodiment, the first heating portion 112a and the second heating portion 112b are of an integral forming structure, and may be formed by bending one heating element 112. It may be understood that, in some other embodiments, the first heating portion 112a and the second heating portion 112b may also be of a split structure, and the first heating portion 112a and the second heating portion 112b may be two heating elements 112, respectively. It may be understood that, in some other embodiments, the second heating portion 112b may also be omitted, or may be replaced by an apyretic conductive rod.

In this embodiment, a conductive portion 1121 is provided at one end of the heating portion 1120 and connected to the heating portion 1120, may be led out from one end of the tube body 111, and may penetrate out of the base 113 to be conductively connected to the power supply assembly 20. In this embodiment, there may be two conductive portions 1121. The two conductive portions 1121 may be spaced apart from each other, respectively connected to the heating portion 1120, and penetrate out of the same end of the tube body 111. In this embodiment, the conductive portions 1121 may be fixed to the heating portion 1120 by means of welding. Of course, it may be understood that, in some other embodiments, the heating portion 1120 may be integrally formed with the conductive portion 1121, and the first free end 112d and the second free end 112e of the heating element 112 may separately form two conductive portions 1121. That is, the first free end 112d of the first heating portion 112a forms one of the conductive portions 1121; and the second free end 112e of the second heating portion 112b forms the other conductive portion 1121. In some other embodiments, the conductive portion 1121 may be a lead wire, which may be welded to the heating portion 1120. Of course, it may be understood that, in some other embodiments, the conductive portion 1121 is not limited to a lead wire, or other conductive structures.

In this embodiment, the heating element 112 includes a heating substrate 1122 and an infrared radiation layer 1124. The heating substrate 1122 may generate heat in a powered-on state. The infrared radiation layer 1124 is provided on the outer surface of the heating substrate 1122. In a powered-on heating state, the heating substrate 1122 may excite the infrared radiation layer 1124 to generate and radiate infrared light waves. In this embodiment, the heating substrate 1122 and the infrared radiation layer 1124 are distributed in a concentric circle on the cross section of the heating portion 1120.

In this embodiment, the heating substrate 1122 may be in the shape of a strip as a whole, and may be circular in cross section. Specifically, the heating substrate 1122 may be a heating wire. Of course, it may be understood that, in some other embodiments, the heating substrate 1122 may also be in the shape of a sheet. That is, the heating substrate 1122 may be a heating sheet. The heating substrate 1122 includes a metal substrate having a high-temperature anti-oxidation property, and the metal substrate may be a metal wire. Specifically, the heating substrate 1122 may be a metal material having good high-temperature anti-oxidation property, high stability, low tendency to deform and other performances, such as a nickel-chromium alloy substrate (e.g., nickel-chromium alloy wire) or an iron-chromium-aluminum alloy substrate (e.g., iron-chromium-aluminum alloy wire). In this embodiment, the radial dimension of the heating substrate 1122 may be 0.15 mm-0.8 mm. The metal wire may be bent or wound into various shapes, such as a spiral shape, a mesh shape, an M shape, or an N shape. The bent or wound heating element has a columnar shape, a spiral segment, a mesh shape, or other three-dimensional or planar shape with bends as a whole.

In this embodiment, the heating element 112 further includes an anti-oxidation layer 1123, and the anti-oxidation layer 1123 is formed between the heating substrate 1122 and the infrared radiation layer 1124. Specifically, the anti-oxidation layer 1123 may be an oxide film. A layer of dense oxide film is generated on the surface of the heating substrate 1122 by performing high-temperature heat treatment. The oxide film forms the anti-oxidation layer 1123. Of course, it may be understood that, in some other embodiments, the anti-oxidation layer 1123 is not limited to including an oxide film formed by the anti-oxidation layer 1123. In some other embodiments, the anti-oxidation layer 1123 may be an anti-oxidation coating applied to the outer surface of the heating substrate 1122. By forming the anti-oxidation layer 1123, it can be ensured that the heating substrate 1122 is not or rarely oxidized when being heated in an air environment, thereby improving the stability of the heating substrate 1122. Further, it is unnecessary to vacuumize the first accommodating cavity 1113 or fill the first accommodating cavity 1113 with a reducing gas, thereby simplifying an assembly process of the entire heating structure 11 and saving the manufacturing cost. In this embodiment, the thickness of the anti-oxidation layer 1123 may be selected to be 1 um-150 um. When the thickness of the anti-oxidation layer 1123 is less than 1 um, the heating substrate 1122 is easily oxidized. When the thickness of the anti-oxidation layer 1123 is greater than 150 um, heat conduction between the heating substrate 1122 and the infrared radiation layer 1124 may be seriously affected.

In this embodiment, the infrared radiation layer 1124 may be a composite infrared layer. The infrared layer may be an infrared layer-forming substrate that is formed, under high-temperature heat treatment, on one side of the anti-oxidation layer 1123 away from the heating substrate 1122. In this embodiment, the infrared layer-forming substrate may be a SiC matrix, a spinel substrate, or a composite substrate thereof. Of course, it may be understood that, in some other embodiments, the infrared radiation layer 1124 is not limited to the infrared layer. In some other embodiments, the infrared radiation layer 1124 may be a composite infrared layer. In this embodiment, the infrared layer may be formed, by means of dipping, spraying, brushing or others, on one side of the anti-oxidation layer 1123 away from the heating substrate 1122. The infrared radiation layer 1124 may have the thickness of 10 um-300 um. When the infrared radiation layer 1124 has a thickness of 10 um-300 um and a good infrared light wave effect, the atomization efficiency and the atomization taste of the aerosol generating substrate 200 are relatively good. Of course, it may be understood that, in some other embodiments, the thickness of the infrared radiation layer 1124 is not limited to 10 um-300 um.

In this embodiment, unlike the heating element of the existing E-cigarette, the maximum operating temperature interval of the heating element 112 may be 500° C.-1300° C. That is, during the entire operating period, the maximum operating temperature of the heating element 112 may be any temperature in the range of 500° C.-1300° C., and may be specifically determined according to a temperature control requirement. However, the maximum operating temperature of a heating element in the prior art is usually within 400° C. Specifically, in this embodiment, the operating temperature intervals of the heating element 112 include a first operating temperature interval and a second operating temperature interval. The first operating temperature interval may be an operating temperature interval during preheating, and the maximum temperature of the first operating temperature interval may be 700° C.-1300° C. At this temperature, the aerosol generating substrate 200 may be preheated by infrared heat within an extremely short time, so as to ensure the amount of smoke and taste of the aerosol in first three or so puffs when a user vapes. Specifically, in the powered-on state, the temperature of the heating element 112 can rise rapidly from room temperature to approximately 1000° C. within 1-3 seconds. The second operating temperature interval may be an operating temperature interval at which the user puffs aerosol that is normally generated by heating the aerosol generating substrate, and the maximum temperature of the second operating temperature interval may be 500° C.-800° C. Of course, it may be understood that, in some other embodiments, division intervals for the operating temperatures of the heating element 112 are not limited to two, for example, a cooling stage at the rear stage of the second operating temperature is further included. Because of the existence of the gap 1114, the surface temperature of the tube body 111 may be controlled to be less than 350° C., and the atomization temperature of the entire aerosol generating substrate is controlled at 300-350° C., so that the aerosol generating substrate 200 is accurately atomized mainly in an infrared band of 2-5 um.

Specifically, as shown in FIG. 7, FIG. 7 is a variation diagram of a temperature curve of the heating element 112 according to this embodiment during operation. A vertical coordinate is the temperature, and a horizontal coordinate corresponds to the number of sampling points, with approximately 15 points corresponding to one second. A peak segment belongs to the preheating time which is approximately 1-5 seconds (it should be noted that the output power may be controlled according to requirements, so that the preheating time is far less than the existing 15 seconds). The preheating time in this solution is preferably 2-3 seconds. As shown in FIG. 7, after the aerosol generating device is started, the temperature of the heating element may rise to be greater than 1000° C. within 2 seconds, allowing for the first puff within approximately 1 second. This rapid temperature increase quickly heats the substrate, reducing waiting time and essentially enabling immediate vaping upon inserting the substrate, thereby greatly improving the experience of a consumer. In addition, in spite of such a rapid temperature and the temperature being higher than 1000° C., the substrate does not become charred, which would otherwise affect the taste. On the contrary, the taste is improved, and the conflict between the charring of the aerosol generating substrate easily caused by the high-temperature operation of the heating element and the requirement for improving the vaping experience is solved. In one embodiment, when the temperature reaches approximately 1200° C., the output power (which may be the voltage) is reduced, and the temperature of the heating element is reduced to approximately 600° C.; this temperature or a small-amplitude temperature pulse is maintained for approximately 5 minutes before cutting off power to complete the vaping. It needs to be noted that regardless of a preheating stage or a stable output stage, a main heating mode remains infrared light waves. However, the infrared light wave bands corresponding to a high-temperature stage and a stable output temperature are different, yet they are all within the bands that can be easily absorbed by the substrate.

A method for manufacturing the heating element 112 includes the following steps. A heating substrate-forming substrate is selected to form a heating substrate 1122. Specifically, a metal wire for infrared light waves (e.g., a nickel-chromium alloy wire or an iron-chromium-aluminum alloy wire) is selected to form the heating substrate 1122, and the metal wire is wound around the heating portion 1120 having a single-spiral shape. Of course, it may be understood that, in some other embodiments, the heating element 112 is not limited to winding of the heating portion 1120 having the single-spiral shape, and the heating element 112 may adopt different winding manners such as a double-spiral shape, an M shape, or an N shape.

Next, an anti-oxidation layer 1123 is provided on the outer surface of the heating substrate 1122. Specifically, the wound heating portion 1120 is placed in a heating furnace (i.e., a muffle furnace) to perform heat treatment, and then cooled to room temperature with the furnace, so as to form an oxide film having the thickness of 1 um-150 um on the outer surface of the heating substrate 1122, thereby forming a heating element preform having the anti-oxidation layer 1123.

Then, the infrared radiation layer-forming substrate is subjected to heat treatment on one side of the anti-oxidation layer 1123 away from the heating substrate 1122, so that the infrared radiation layer 1124 is formed on the outer surface of the heating substrate 1122. Specifically, the infrared layer-forming substrate (e.g., SiC or spinel) may be applied to one side of the anti-oxidation layer 1123 away from the heating substrate 1122 by means of dipping, spraying, brushing or other manners, and the coating thickness of the infrared layer-forming substrate is controlled to 10 um-300 um. The heating element preform coated with the infrared layer-forming substrate is first subjected to heat treatment by using a tunnel furnace, then placed in the heating furnace (e.g., the muffle furnace) to perform heat treatment at the temperature higher than the temperature of treatment in the tunnel furnace, and then cooled to room temperature with the furnace. It should be noted that in another embodiment, the infrared radiation layer 1124 may be directly formed on the outer surface of the heating substrate 1122, without pre-forming an oxide film.

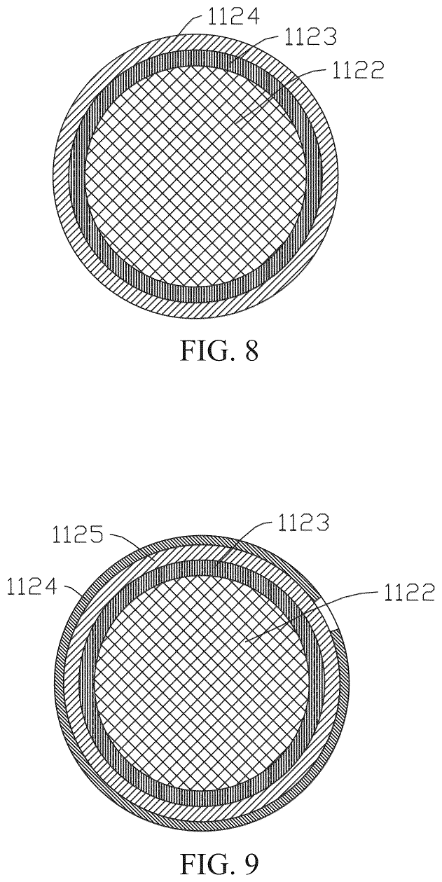

FIG. 8 shows a second embodiment of an aerosol generating device of the present disclosure, which is different from the first embodiment in that the infrared radiation layer 1124 is a composite infrared layer, and the composite infrared layer may be formed by compounding an infrared layer-forming substrate and a binding body configured to bind to the anti-oxidation layer 1123. Specifically, the binding body may be glass powder, and the composite infrared layer may be a glass powder composite infrared layer. The reason for using the glass powder is that the glass powder can melt at high temperatures to form the combination of the anti-oxidation layer 1123 and the infrared layer, and can also seal a gap in the infrared layer-forming substrate, thereby enhancing an anti-breakdown function. The glass powder composite infrared layer is prepared by adding the glass powder to the infrared layer-forming substrate (e.g., SiC or spinel) and compounding, then coating to one side of the anti-oxidation layer 1123 away from the heating substrate 1122 by means of dipping, spraying, brushing or other manners, then performing heat treatment, putting into the heating furnace for heat treatment at the temperature higher than the temperature of treatment in the tunnel furnace, and then cooling to room temperature with the furnace.

FIG. 9 shows a third embodiment of an aerosol generating device of the present disclosure, which is different from the first embodiment in that the heating element 112 further includes a binding layer 1125 provided between the anti-oxidation layer 1123 and the infrared radiation layer 1124. The binding layer 1125 may be configured to prevent partial breakdown of the heating substrate 1122, and further improve the binding force between the anti-oxidation layer 1123 and the infrared radiation layer 1124. In some embodiments, the binding body in the binding layer 1125 may be glass powder. That is, the binding layer 1125 may be a glass powder layer.

In some embodiments, the binding body may also be added to the infrared radiation layer 1124, and the binding layer 1125 may be optional glass powder whose melting point is greater than that of the glass powder in the infrared radiation layer 1124.

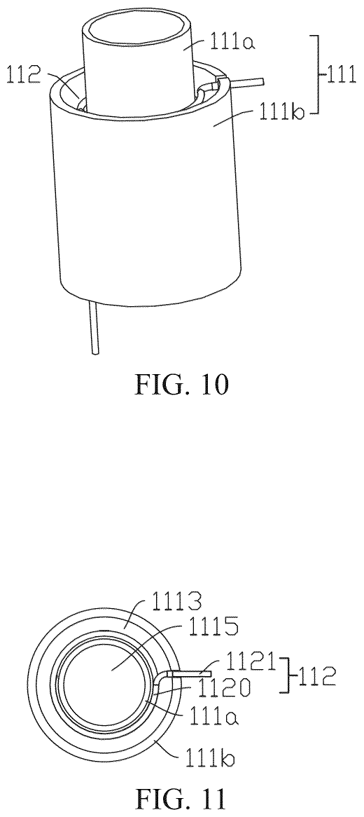

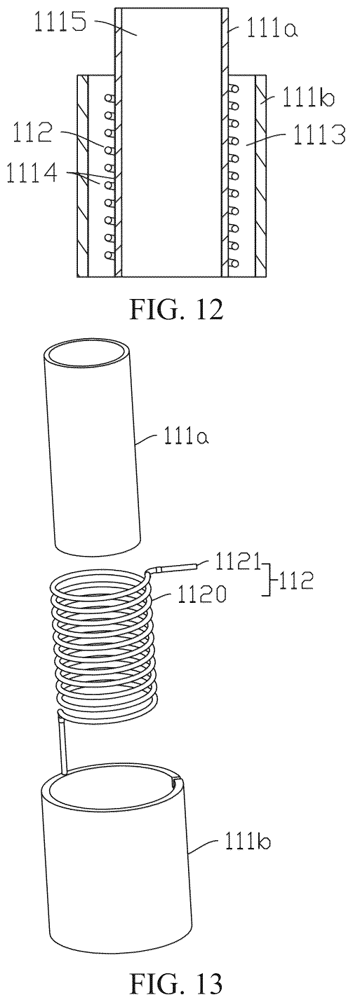

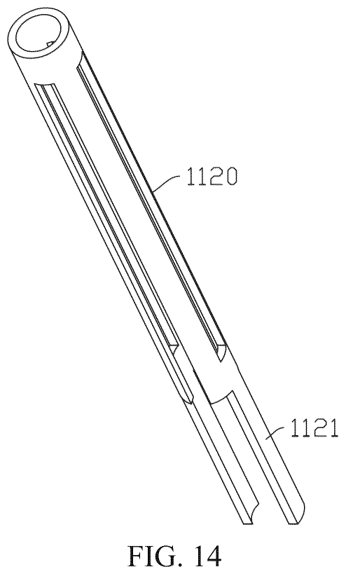

FIG. 10 to FIG. 13 show a fourth embodiment of an aerosol generating device of the present disclosure, which is different from the first embodiment in that the heating structure 11 is not limited to being partially inserted into the aerosol generating substrate 200 to heat the aerosol generating substrate 200. In this embodiment, the heating structure 11 may be sleeved on the periphery of a substrate section of the aerosol generating substrate 200, and the aerosol generating substrate 200 is heated by means of peripheral heating. In this embodiment, the tube body 111 includes a first tube body 111a and a second tube body 111b, and the first tube body 111a is of a hollow structure with both ends being communicated. The first tube body 111a may be columnar, and has the inner diameter slightly greater than the outer diameter of the aerosol generating substrate 200. A second accommodating cavity 1115 may be formed on the inner side of the first tube body 111a and configured to accommodate the aerosol generating substrate 200 and form a heating space allowing the substrate section of the aerosol generating substrate 200 to be heated. The axial length of the first tube body 111a may be greater than the axial length of the second tube body 111b. The second tube body 111b may be sleeved on the periphery of the first tube body 111a. The second tube body 111b may be columnar. The radial dimension of the second tube body 111b may be greater than the radial dimension of the first tube body 111a. That is, a spacing is reserved between the second tube body 111b and the first tube body 111a. The spacing may form the first accommodating cavity 1113. The first accommodating cavity 1113 is configured to accommodate the heating element 112. In some embodiments, the heating element 112 is provided around the periphery of the first tube body 111a, and a gap 1114 is reserved between the whole heating element and the inner wall of the second tube body 111b as well as the outer wall of the first tube body 111a, so that a defined temperature difference may be formed between the inner wall of the first accommodating cavity 1113 and the heating element 112, thereby achieving a heat insulation function. In some embodiments, a reflective layer may be provided on the inner wall of the second tube body 111b, and configured to reflect heat of the heating element 112 and radiate the heat to the aerosol generating substrate 200, thereby enhancing the energy efficiency of heating.

In some other embodiments, the heating element 112 is not limited to being completely spaced apart from the first tube body 111a or the second tube body 111b. In some other embodiments, the heating element 112 may be partially spaced apart from the first tube body 111a, and the radial dimension of a partial segment of the heating portion 1120 may be equivalent to the outer diameter of the first tube body 111a, achieving a position limiting function. In some other embodiments, the heating element 112 may also be partially spaced apart from the second tube body 111b, and the radial dimension of a partial segment of the heating portion 1120 may be equivalent to the radial dimension of the second tube body 111b.

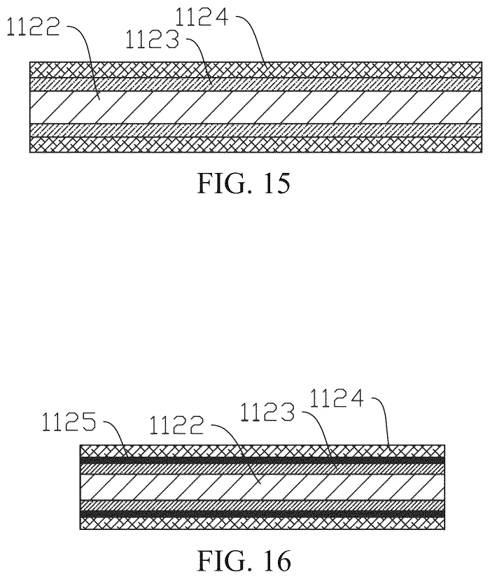

FIG. 14 to FIG. 15 show a fifth embodiment of an aerosol generating device of the present disclosure, which is different from the first embodiment in that the heating element 112 may be in the shape of a sheet, and may be wound into a columnar heating portion 1120. The heating substrate 1122, the anti-oxidation layer 1123 and the infrared radiation layer 1124 may be stacked to form a structure similar to a “sandwich”.

FIG. 16 shows a sixth embodiment of an aerosol generating device of the present disclosure, which is different from the fifth embodiment in that a binding layer 1125 is provided between the infrared radiation layer 1124 and the anti-oxidation layer 1123.

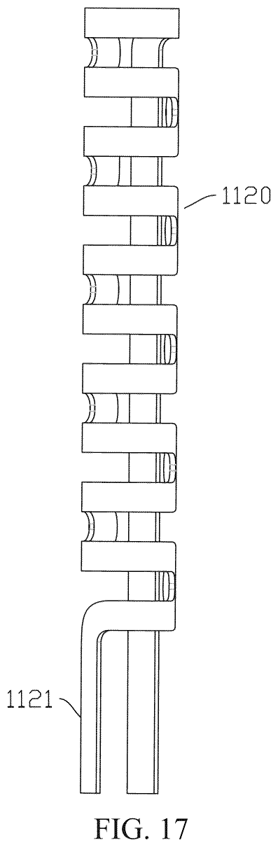

FIG. 17 shows a seventh embodiment of an aerosol generating device of the present disclosure, which is different from the fifth embodiment in that the heating element 112 may be bent to form a heating portion 1120 having the shape of a snap spring.

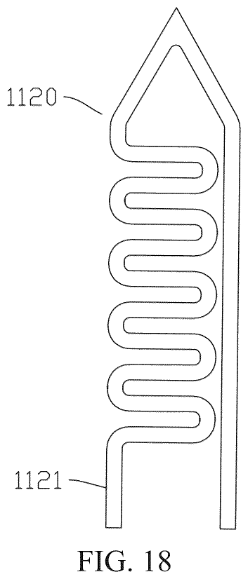

FIG. 18 shows an eighth embodiment of an aerosol generating device of the present disclosure, which is different from the fifth embodiment in that the heating element 112 may be bent, and the heating portion 1120 may be in the shape of a sheet as a whole.

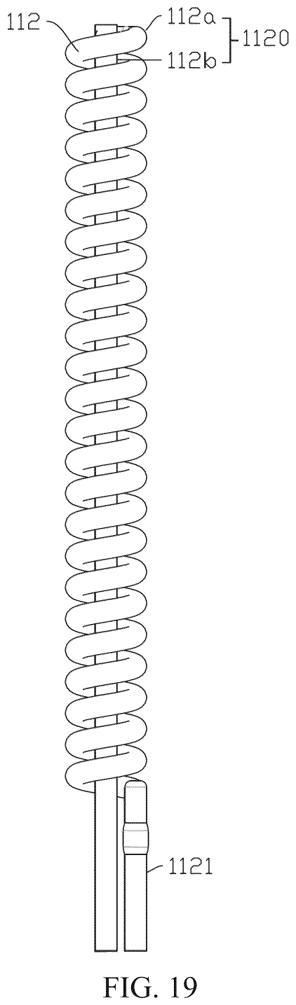

FIG. 19 shows a ninth embodiment of an aerosol generating device of the present disclosure, which is different from the first embodiment in that the first heating portion 112a and the second heating portion 112b may be of a split structure. The first heating portion 112a and the second heating portion 112b are two independent heating elements 112, respectively. Of course, it may be understood that, the second heating portion 112b may also be replaced with an apyretic conductive rod.

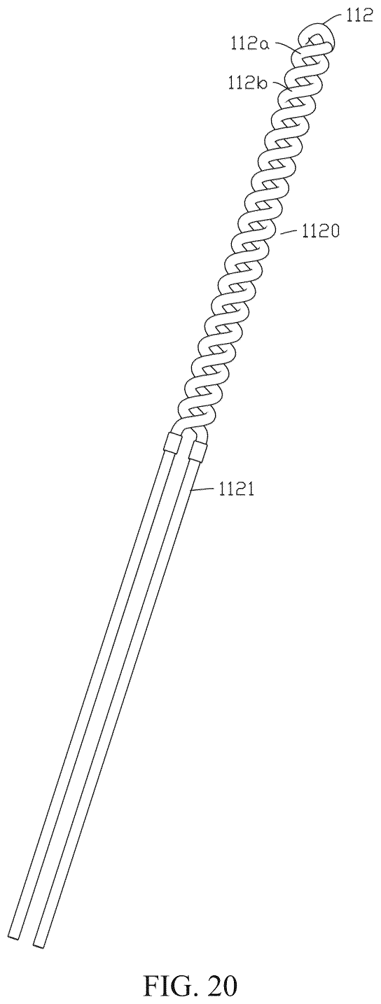

FIG. 20 shows a tenth embodiment of an aerosol generating device of the present disclosure, which is different from the first embodiment in that the heating element 112 may be wound in a double-spiral winding manner to form a heating portion 1120 having a double-spiral structure, and the heating portion 1120 has a hollow structure. Of course, it may be understood that, in some other embodiments, a support rod may be provided at the center of the heating portion 1120.

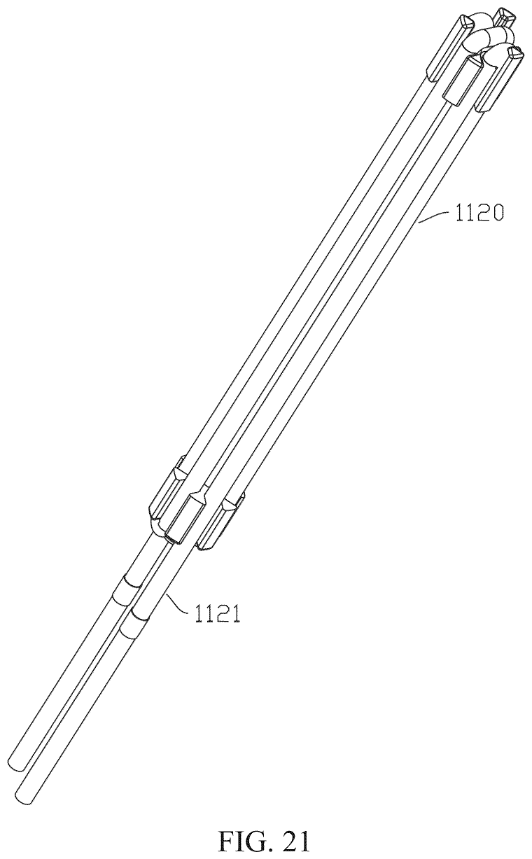

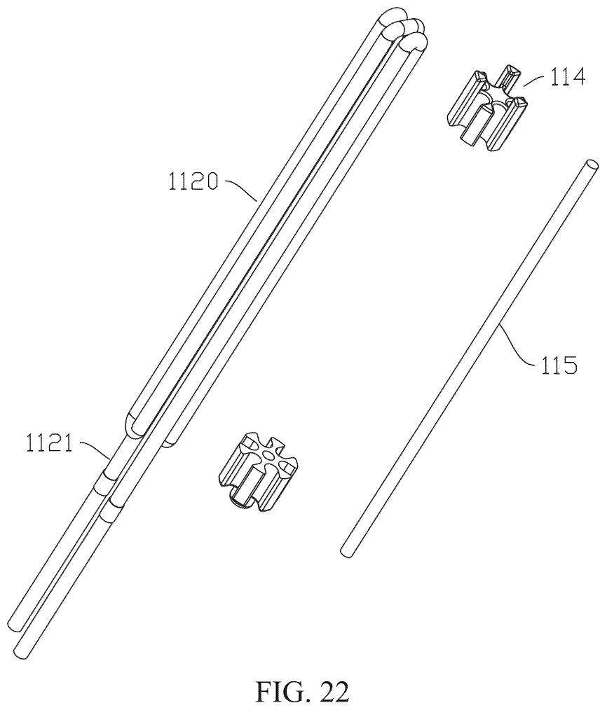

FIG. 21 and FIG. 22 show an eleventh embodiment of an aerosol generating device of the present disclosure, which is different from the first embodiment in that the heating element 112 may form the heating portion 1120 in an M-winding manner. Specifically, the heating structure 11 may include two bobbins 114. The two bobbins 114 may be spaced apart from each other, and the heating element 112 may be wound on the two bobbins 114. The two bobbins 114 are identical in structure and radial dimension, so that the dimensions of the entire heating portion 1120 in a radial direction of the bobbins 114 are evenly distributed in an axial direction of the heating portion 1120. In this embodiment, the heating structure 11 further includes a support rod 115. The support rod 115 may be provided between the two bobbins 114, achieving a supporting function.

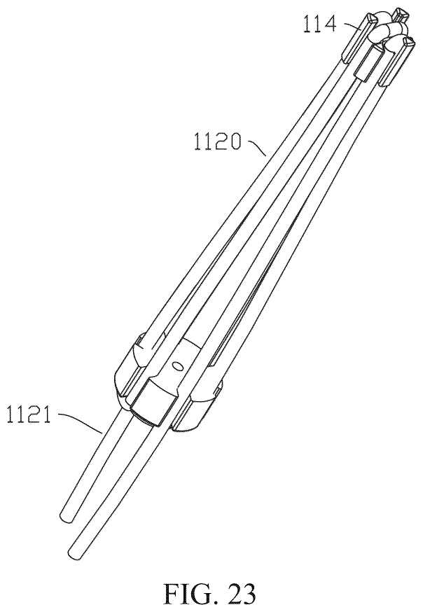

FIG. 23 shows a twelfth embodiment of the aerosol generating device of the present disclosure, which is different from the second embodiment in that the radial dimension of one of the bobbins 114 is smaller than the radial dimension of the other bobbin 114, so that the entire heating portion 1120 may have a conical shape, and the conductive portion 1121 may penetrate out of the bobbin 114 having a larger radial dimension.

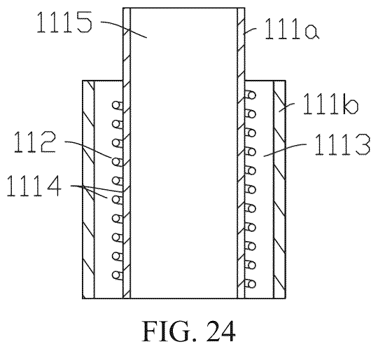

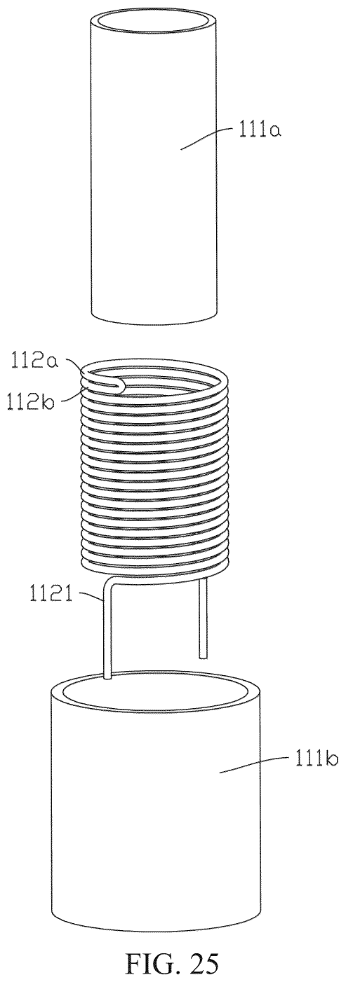

FIG. 24 to FIG. 25 show a thirteenth embodiment of an aerosol generating device of the present disclosure, which is different from the fourth embodiment in that the heating element 112 forms the heating portion 1120 in a double-spiral winding manner.

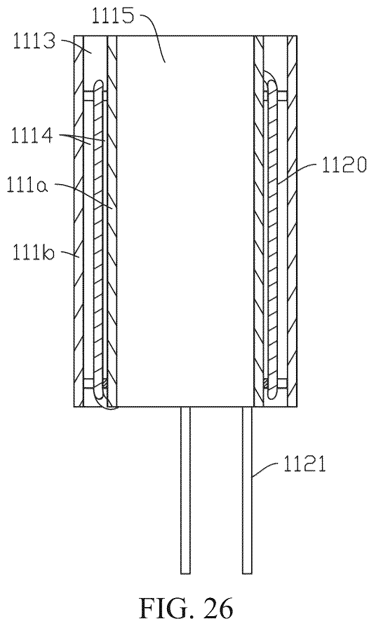

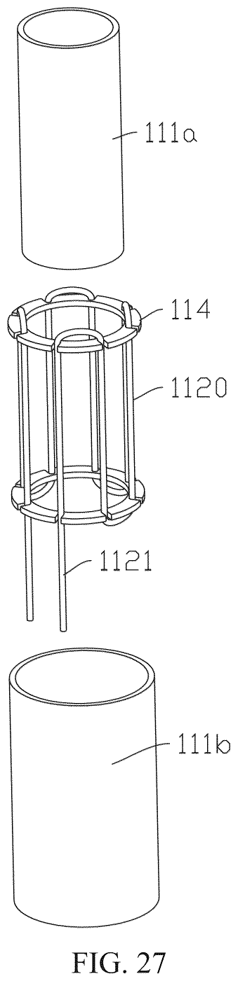

FIG. 26 to FIG. 27 show a fourteenth embodiment of an aerosol generating device of the present disclosure, which is different from the fourteenth embodiment in that the heating element 112 forms the heating portion 1120 in an M-winding manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating element; and
a tube body,
wherein the heating element comprises a heating substrate and an infrared radiation layer provided on an outer surface of the heating substrate,
wherein the heating substrate is configured to be powered on for heating and exciting the infrared radiation layer to radiate infrared light waves,
wherein the heating element is at least partially spaced apart from a tube wall of the tube body,
wherein the tube wall of the tube body is configured to allow the infrared light waves to penetrate through, and
wherein the infrared light waves are configured to heat an aerosol generating substrate.

2. The heating structure of claim 1, wherein the tube body comprises infrared-transparent glass, transparent ceramic, or diamond.

3. The heating structure of claim 1, wherein a maximum operating temperature of the heating element is 500° C.-1300° C.

4. The heating structure of claim 1, wherein operating temperature intervals of the heating element comprise at least a first operating temperature interval and a second operating temperature interval,
wherein a maximum temperature of the first operating temperature interval is 700° C.-1300° C., and
wherein a maximum temperature of the second operating temperature interval is 500° C.-800° C.

5. The heating structure of claim 1, wherein the heating element is completely spaced apart from the tube wall of the tube body.

6. The heating structure of claim 1, wherein the heating element is disposed in no direct contact with the tube body.

7. The heating structure of claim 1, wherein the tube wall of the tube body has a thickness of 0.15 mm-0.6 mm.

8. The heating structure of claim 1, wherein a spacing between the tube wall of the tube body and the heating element is 0.05 mm-1 mm.

9. The heating structure of claim 1, wherein the heating substrate has a circular strip shape in a cross section, and
wherein a radial dimension of the heating substrate is 0.15 mm-0.8 mm.

10. The heating structure of claim 1, wherein the heating substrate has a flat strip shape in cross section, and
wherein the heating substrate has a thickness of 0.15 mm-0.8 mm.

11. The heating structure of claim 1, wherein the heating substrate is in the shape of a sheet, a mesh, or a film, and
wherein the heating substrate has a thickness of 10 um-500 um.

12. The heating structure of claim 1, wherein the infrared radiation layer has a thickness of 10 um-300 um.

13. The heating structure of claim 1, further comprising:
an anti-oxidation layer provided between the heating substrate and the infrared radiation layer.

14. The heating structure of claim 13, wherein the anti-oxidation layer has a thickness of 1 um-150 um.

15. The heating structure of claim 13, further comprising:
a binding layer provided between the anti-oxidation layer and the infrared radiation layer.

16. The heating structure of claim 15, wherein the binding layer has a thickness of 10 um-70 um.

17. The heating structure of claim 13, wherein the infrared radiation layer comprises an infrared layer and/or a composite infrared layer, and
wherein the composite infrared layer is formed by compounding an infrared layer-forming substrate and a binding body configured to bind to the anti-oxidation layer.

18. The heating structure of claim 1, wherein the heating substrate comprises a metal substrate, and
wherein the metal substrate comprises a nickel-chromium alloy substrate or an iron-chromium-aluminum alloy substrate.

19. The heating structure of claim 1, wherein the heating element is provided lengthwise.

20. The heating structure of claim 1, wherein the heating element comprises a column, a strip, a sheet, a spiral, or a mesh.

21. The heating structure of claim 1, wherein the heating element is at least partially bent.

22. The heating structure of claim 21, wherein the heating element is bent to form a heating portion having at least one bending segment, and
wherein the heating portion comprises a column, a spiral, or a mesh.

23. The heating structure of claim 1, wherein the tube body comprises a hollow tube in which a first accommodating cavity configured to accommodate the heating element is formed.

24. The heating structure of claim 1, wherein the heating element are spaced apart from a periphery of the tube body, and
wherein the tube body is hollow inside to form a second accommodating cavity configured to accommodate an aerosol substrate.

25. The heating structure of claim 1, wherein the tube body comprises a first tube body configured to allow light waves to penetrate through and a second tube body sleeved on a periphery of the first tube body,
wherein a spacing is reserved between the second tube body and the first tube body, and the spacing forms the first accommodating cavity for accommodating the heating element, and
wherein the heating element is provided on the periphery of the first tube body and spaced apart from the first tube body.

26. An aerosol generating device, comprising:
the heating structure of claim 1; and
a power supply assembly configured to supply power to the heating structure.

27. A heating element, comprising:
a heating substrate; and
an infrared radiation layer provided on an outer surface of the heating substrate,
wherein the heating substrate is configured to be powered on for heating and exciting the infrared radiation layer to radiate infrared light waves to heat an aerosol generating substrate installed in an accommodating cavity of an aerosol generating device, and
wherein the heating substrate is spaced apart from a cavity wall of the accommodating cavity.

28. The heating element of claim 27, wherein the heating substrate has a circular strip shape in cross section, and
wherein a radial dimension of the heating substrate is 0.15 mm-0.8 mm.

29. The heating element of claim 27, wherein the heating substrate comprises a sheet, and
wherein the heating substrate has a thickness of 0.15 mm-0.8 mm.

30. The heating element of claim 27, wherein the infrared radiation layer has a thickness of 10 um-300 um.

31. The heating element of claim 27, further comprising:
an anti-oxidation layer provided between the heating substrate and the infrared radiation layer.

32. The heating element of claim 31, wherein the anti-oxidation layer has a thickness of 1 um-150 um.

33. The heating element of claim 32, further comprising:
a binding layer provided between the anti-oxidation layer and the infrared radiation layer.

34. The heating element of claim 33, wherein the binding layer has a thickness of 10 um-70 um.

35. The heating element of claim 33, wherein the infrared radiation layer comprises an infrared layer and/or a composite infrared layer, and
wherein the composite infrared layer is formed by compounding an infrared layer-forming substrate and a binding body configured to bind to the anti-oxidation layer.

36. The heating element of claim 27, wherein the heating substrate comprises a metal substrate, and
wherein the metal substrate comprises a nickel-chromium alloy substrate or an iron-chromium-aluminum alloy substrate.

37. The heating element of claim 27, wherein a maximum operating temperature of the heating element is 500° C.-1300° C.

38. The heating element of claim 27, wherein operating temperature intervals of the heating element comprise at least a first operating temperature interval and a second operating temperature interval,
wherein a maximum temperature of the first operating temperature interval is 700° C.-1300° C., and
wherein a maximum temperature of the second operating temperature interval is 500° C.-800° C.

39. The heating element of claim 27, wherein the heating element is provided lengthwise.

40. The heating element of claim 27, wherein the heating element comprises a strip, a sheet, a spiral, or a mesh.

41. A method for manufacturing a heating element, comprising:
selecting a heating substrate-forming substrate to form a heating substrate;
performing heat treatment on an infrared radiation layer-forming substrate on an outer surface of the heating substrate so as to allow an infrared radiation layer to be formed on the outer surface of the heating substrate.

42. The method for manufacturing the heating element of claim 41, further comprising:
providing an anti-oxidation layer on the outer surface of the heating substrate; and
forming the infrared radiation layer on one side of the anti-oxidation layer away from the heating substrate.

43. The method for manufacturing the heating element of claim 42, further comprising:
coating a binding body on the anti-oxidation layer to form a binding layer, the binding body being configured to bind the anti-oxidation layer to the infrared radiation layer.

44. The method for manufacturing the heating element of claim 43, wherein the infrared radiation layer comprises an infrared layer and/or a composite infrared layer, and
wherein the composite infrared layer is formed by compounding an infrared layer-forming substrate and a binding body configured to bind to the anti-oxidation layer.

45. The method for manufacturing the heating element of claim 41, wherein the heating substrate-forming substrate comprises a metal substrate, and
wherein the metal substrate comprises a nickel-chromium alloy substrate or an iron-chromium-aluminum alloy substrate.

46. The method for manufacturing the heating element of claim 41, wherein the heating substrate has a circular strip shape in cross section, and
wherein a radial dimension of the heating substrate is 0.15 mm-0.8 mm.

47. The method for manufacturing the heating element of claim 41, wherein the heating substrate comprises a sheet, and
wherein the heating substrate has a thickness of 0.15 mm-0.8 mm.

48. The method for manufacturing the heating element of claim 41, wherein the infrared radiation layer has a thickness of 10 um-300 um.

49. The method for manufacturing the heating element of claim 42, wherein the anti-oxidation layer has a thickness of 1 um-150 um.

50. The method for manufacturing the heating element of claim 43, wherein the binding layer has a thickness of 10 um-70 um.
